(19) United States
(12) Patent Application Publication
(10) Pub. No.: US 2018/0075779 A1
(43) Pub. Date: Mar. 15, 2018

(54) TRAINING ASSISTANCE APPARATUS

(71) Applicant: JTEKT CORPORATION, Osaka-shi (JP)

(72) Inventors: Toshiyuki TSUZUKI, Anjo-shi (JP); Toshio AONO, Chiryu-shi (JP)

(73) Assignee: JTEKT CORPORATION, Osaka-shi (JP)

(21) Appl. No.: 15/700,490

(22) Filed: Sep. 11, 2017

(30) Foreign Application Priority Data
Sep. 13, 2016 (JP) 2016-178995

(51) Int. Cl. G09B 25/02; G09B 19/24

(52) U.S. Cl. CPC G09B 25/02; G09B 19/24

(57) ABSTRACT

A training assistance apparatus includes a skilled operation condition acquiring unit configured to acquire an operation condition of a skilled operator on a processing machine in advance, and an unskilled operation condition acquiring unit configured to acquire, when an unskilled operator executes an operation, an operation condition of the unskilled operator so that the operation condition of the unskilled operator is comparable with the operation condition acquired by the skilled operation condition acquiring unit for training of the unskilled operator.

### INCORPORATION BY REFERENCE

The disclosure of Japanese Patent Application No. 2016-178995 filed on Sep. 13, 2016 including the specification, drawings and abstract, is incorporated herein by reference in its entirety.

### BACKGROUND OF THE INVENTION

### 1. Field of the Invention

The present invention relates to a training assistance apparatus.

### 2. Description of the Related Art

In operations to be executed on processing machines (for example, machine tools or industrial robots), skilled operators and unskilled operators have a remarkable difference in their operation abilities. In general, the unskilled operators are trained by providing instructions from the skilled operators to the unskilled operators.

Japanese Patent Application Publication No. 2014-178449 (JP 2014-178449 A) describes a training assistance apparatus that contributes to efficient training of operators according to situations. The training assistance apparatus includes an ability information acquiring unit configured to acquire ability information on abilities of one, two, or more operators, an operation history acquiring unit configured to acquire operation history information on operation histories of one, two, or more operators, an operation request history acquiring unit configured to acquire operation request history information on operation requests from one, two, or more customers, and a training priority determining unit configured to determine training priority of contents of training for each operator based on the ability information, the operation history information, and the operation request history information.

Japanese Patent Application Publication No. 2006-133443 (JP 2006-133443 A) describes a training course navigation system configured to provide necessary training curricula according to individual abilities. This system navigates optimum training plans by displaying training curricula important to the trainees based on personal information, training information, and weighting information obtained by attributes of organization or the like.

It is not easy for unskilled operators to learn know-how of skilled operators only by instructions from the skilled operators. That is, it is impossible for the skilled operators to explain all the motions by words and not easy for the skilled operators to discern a difference between operations executed by the skilled operators and operations executed by the unskilled operators. Therefore, a great deal of experience is required to master the operations on the processing machines such as machine tools or industrial robots. As a result, a great deal of time and cost is required to train the operators. Those circumstances lead to a demand to achieve more efficient training of unskilled operators.

### SUMMARY OF THE INVENTION

It is one object of the present invention to provide a training assistance apparatus with which unskilled operators can efficiently learn operational know-how by allowing the unskilled operators to easily grasp a difference between operations executed by skilled operators and operations executed by the unskilled operators.

A training assistance apparatus according to one aspect of the present invention includes a skilled operation condition acquiring unit configured to acquire an operation condition of a skilled operator on a processing machine in advance, and an unskilled operation condition acquiring unit configured to acquire, when an unskilled operator executes an operation, an operation condition of the unskilled operator so that the operation condition of the unskilled operator is comparable with the operation condition acquired by the skilled operation condition acquiring unit for training of the unskilled operator.

As described above, the training assistance apparatus acquires the operation condition of the skilled operator and the operation condition of the unskilled operator so that a comparison can be made therebetween. By comparing the operation condition of the skilled operator and the operation condition of the unskilled operator, the unskilled operator easily grasps a difference between the operation executed by the unskilled operator and the operation executed by the skilled operator as well as know-how. As a result, the unskilled operator can efficiently learn the operational know-how.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a layout diagram of a facility of an embodiment of the present invention;

FIG. 2 is a diagram illustrating the internal configuration of the facility; FIG. 3A is a diagram illustrating an operation procedure and display contents at the start of operation on an operator's terminal (home terminal, portable terminal, or operator's panel) in FIG. 2;

FIG. 3B is a diagram illustrating an operation procedure and display contents at the completion of operation on the operator's terminal (home terminal, portable terminal, or operator's panel) in FIG. 2;

FIG. 4 is a diagram illustrating the configuration of a management apparatus illustrated in FIG. 1 and FIG. 2;

FIG. 5 is a diagram illustrating contents to be displayed on a display device in FIG. 4, including initial process schedules, process results, and updated process schedules (planned tasks);

FIG. 6 is a diagram illustrating operation result information of operators, which is stored in an ability database in FIG. 4;

FIG. 7 is a flowchart illustrating processing to be performed by a subsequent operation determining unit in FIG. 4;

FIG. 8 is a diagram illustrating the configuration of a training assistance apparatus illustrated in FIG. 2; and

FIG. 9 is a diagram illustrating display contents to be displayed on a display unit illustrated in FIG. 8.

### DETAILED DESCRIPTION OF EMBODIMENTS

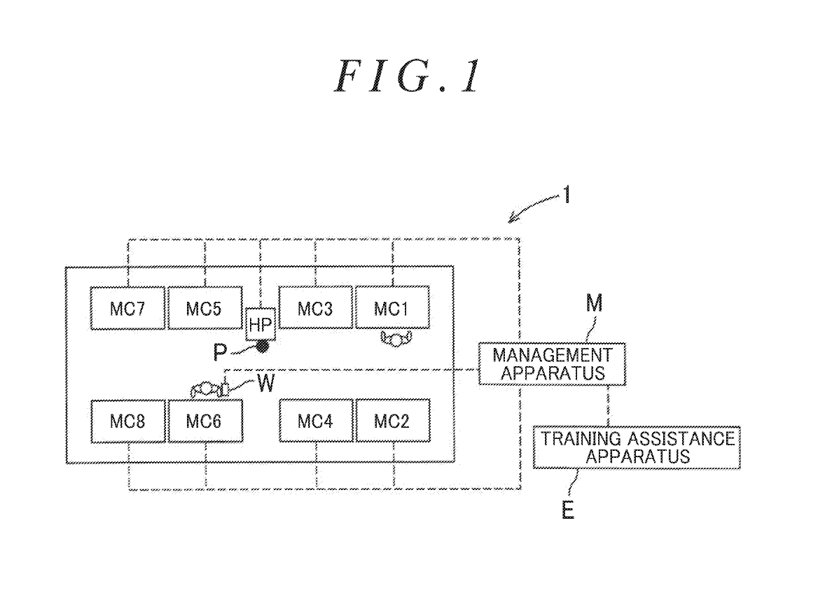

The configuration of a facility 1 is described with reference to FIG. 1. The facility 1 is, for example, a production facility for producing various objects, or a physical distribution facility for transporting objects. In this embodiment, a production facility for machining objects is taken as an example of the facility 1. The facility 1 is a non-fully automated facility where operators work. That is, processing to be executed by processing machines MC1 to MC8 constituting the facility 1 is not completely automated in the facility 1, but the operators are required to operate the processing machines MC1 to MC8

As illustrated in FIG. 1, the facility 1 includes eight processing machines MC1 to MC8, a home terminal HP, a plurality of portable terminals W, and a management apparatus M. The object to be produced is, for example, a cylindrical member.

The processing machines MC1 to MC8 are, for example, machine tools such as a machining center, a lathe, and a grinding machine. The order from the processing machine MC1 to the processing machine MC8 corresponds to the order of process steps. The processing machines MC1 to MC8 are arranged in two rows. The processing machines MC1 to MC8 in the respective rows are arranged with their front sides facing each other.

The processing machines MC1 to MC8 are arranged in order from a lathe configured to execute rough machining of an outer profile, a grinding machine configured to execute semi-finishing of the outer profile, a lathe configured to execute rough machining of an inner profile, a grinding machine configured to execute semi-finishing of the inner profile, a grinding machine configured to execute finishing of a straight portion of the outer profile, a grinding machine configured to execute finishing of a tapered portion of the outer profile, a grinding machine configured to execute finishing of a straight portion of the inner profile, and a grinding machine configured to execute finishing of a tapered portion of the inner profile.

The home terminal HP is installed at a home position P in the facility 1. The home position P is a reference position in the facility 1, and is defined from the viewpoint of operations. The home terminal HP is an apparatus for assigning an operation to an operator and allowing the operator to input operation start information and operation completion information. The operator inputs information on the home terminal HP every time an operation is started or completed. From the viewpoint of an operator's moving range, the home position P where the home terminal HP is installed is set near the center of the entire facility 1. The home position P where the home terminal HP is installed is not limited to the position near the center of the facility 1, but is determined as appropriate depending on the arrangement of the processing machines MC1 to MC8 constituting the facility 1.

The portable terminal W is a terminal that has the same functions as those of the home terminal HP and can be carried by an operator. That is, the portable terminal W is a device for assigning an operation to an operator and allowing the operator to input operation start information and operation completion information. The type of the portable terminal W may be a hand-held type or a wearable type. Examples of the hand-held type include a tablet, a mobile phone, a smartphone, and other unwearable devices. Examples of the wearable type include an arm band type, a glasses type, an earphone type, and a helmet-mounted type.

Any one of the home terminal HP and the portable terminal W may selectively be used because the home terminal HP and the portable terminal W have the same functions. When both of the home terminal HP and the portable terminal W are used, for example, an unskilled operator is allowed to use only the home terminal HP, and a skilled operator is allowed to use both of the home terminal HP and the portable terminal W. As described later, when the portable terminal W is used, an operation time is estimated as one element of an operation ability, and thus the operation ability of the operator cannot be grasped accurately. Therefore, it is appropriate that the operator be allowed to use the portable terminal W when the operation ability of the operator is stable to some extent, that is, when the operator is skilled.

The management apparatus M manages processing to be executed by the processing machines MC1 to MC8 and operations to be executed by operators on the processing machines MC1 to MC8. Specifically, the management apparatus M has functions of grasping utilization results, creating updated process schedules, assigning subsequent operations to operators, and constructing an ability database of operators. The management apparatus M is connected to the processing machines MC1 to MC8 and the home terminal HP via a wired or wireless communication network. The management apparatus M is connected to the portable terminals W via a wireless communication network.

The training assistance apparatus E is an apparatus for training unskilled operators by using information stored in the management apparatus M. In particular, the training assistance apparatus E displays, for example, information to be used for the unskilled operators to grasp their operation abilities, and information to be used for comparison between operations executed by the unskilled operators and operations executed by the skilled operators.

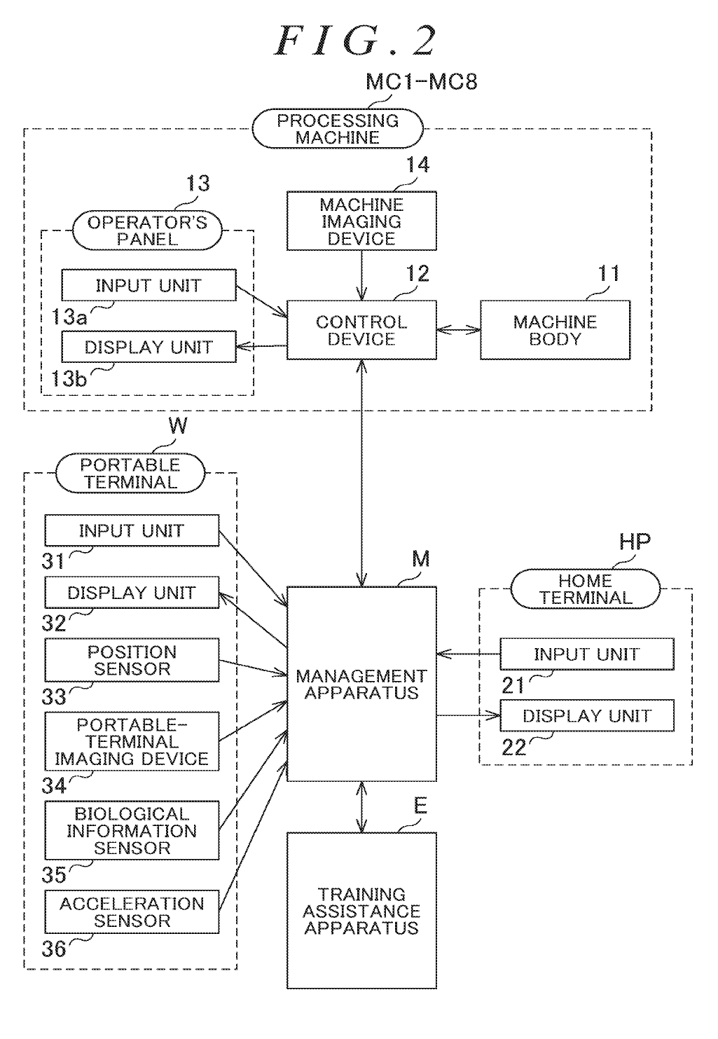

Next, the internal configurations of the processing machines MC1 to MC8, the home terminal HP, and the portable terminal W are described with reference to FIG. 2.

Each of the processing machines MC1 to MC8 includes a machine body 11, a control device 12, an operator's panel 13, and a machine imaging device 14 (first imaging device). The operator's panel 13 includes an input unit 13a and a display unit 13b. The machine imaging device 14 is a device for imaging the surroundings of each of the processing machines MC1 to MC8, in particular, imaging operator's motion.

The home terminal HP includes an input unit 21 and a display unit 22. The portable terminal W includes an input unit 31, a display unit 32, a position sensor 33, a portable-terminal imaging device 34 (second imaging device), a biological information sensor 35, and an acceleration sensor 36. The position sensor 33 of the portable terminal W is a sensor for recognizing the position of the portable terminal Win the facility 1. For example, the position sensor 33 is a GPS sensor. The portable-terminal imaging device 34 images an operator's visual field. The biological information sensor 35 detects operator's pulse and respiration waves. The acceleration sensor 36 detects signals corresponding to operator's motion (for example, walking or standing state).

The input unit 13a of the operator's panel 13, the input unit 21 of the home terminal HP, and the input unit 31 of the portable terminal W are, for example, touch panels on which information can be input by touch operation, or mechanical buttons.

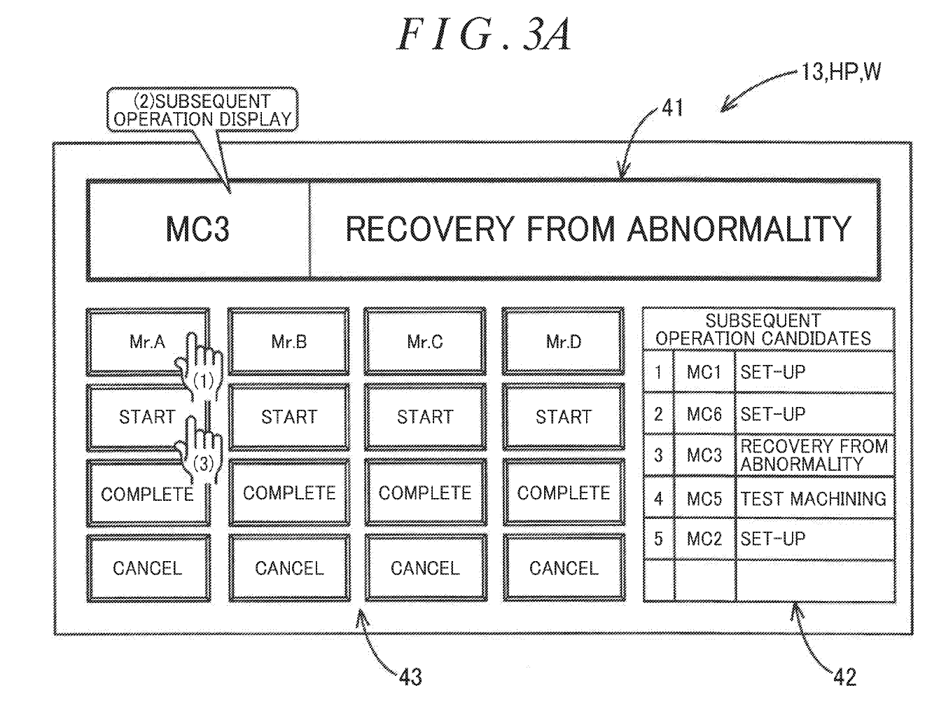

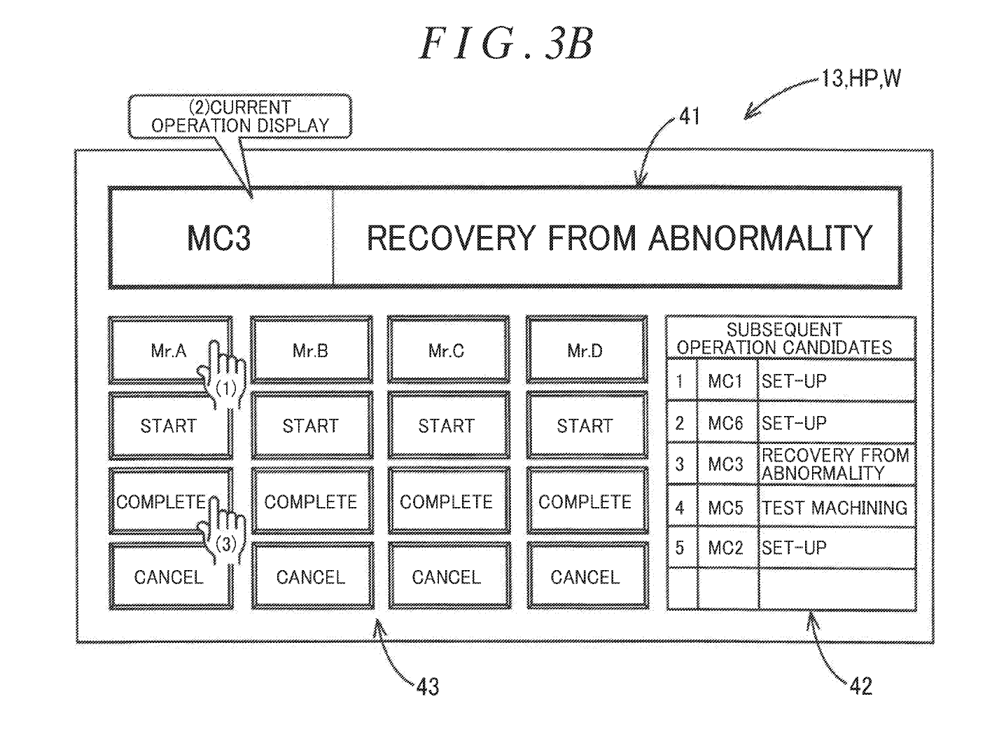

Each of the operator's panel 13, the home terminal HP, and the portable terminal W is an apparatus or device for providing an instruction to an operator and allowing the operator to input information. Therefore, the operator's panel 13, the home terminal HP, and the portable terminal W are hereinafter referred to collectively as operator's terminal 13, HP, W. The configuration of the operator's terminal 13, HP, W is described with reference to FIG. 3A and FIG. 3B.

As illustrated in FIG. 3A and FIG. 3B, the operator's terminal 13, HP, W has an operation display field 41 for displaying a subsequent or current operation, a candidate field 42 for displaying a list of subsequent operation candidates, and an input field 43 for displaying operator's name buttons and start buttons, completion buttons, and cancellation buttons for operations of the respective operators.

The operation display field 41 displays one of the processing machines MC1 to MC8 to be operated and an operation category. The operation display field 41 functions as a field for assigning a subsequent operation to an operator who intends to start the subsequent operation as illustrated in FIG. 3A, and also as a field for displaying a current operation for an operator who intends to complete the current operation as illustrated in FIG. 3B.

The candidate field 42 displays operations that can currently be executed by an operator (hereinafter referred to as subsequent operation candidates). The candidate field 42 displays the processing machines MC1 to MC8 to be operated and the operation categories. The candidate field 42 also displays priority levels when a plurality of subsequent operation candidates is displayed.

Next, an operation procedure to be followed by an operator when the operator starts a subsequent operation is described with reference to FIG. 3A. The candidate field 42 of the operator's terminal 13, HP, W constantly displays subsequent operation candidates that can be executed currently. An operator who is not currently executing any operation touches his/her operator's name button on the operator's terminal 13, HP, W (indicated by (1) in FIG. 3A). Then, the operation display field 41 of the operator's terminal 13, HP, W displays a subsequent operation (indicated by (2) in FIG. 3A). This subsequent operation is one of the subsequent operation candidates displayed in the candidate field 42. That is, the operator's terminal 13, HP, W assigns the subsequent operation to the operator. Then, the operator starts the assigned subsequent operation by touching the start button (indicated by (3) in FIG. 3A).

Next, an operation procedure to be followed by an operator when the operator completes a current operation is described with reference to FIG. 3B. An operator who completes an operation on one of the processing machines MC1 to MC8 touches his/her operator's name button on the operator's terminal 13, HP, W (indicated by (1) in FIG. 3B). Then, the operation display field 41 of the operator's terminal 13, HP, W displays the current operation (indicated by (2) in FIG. 3B). That is, the operator can view the current operation in the operation display field 41. Then, the operator completes the current operation by touching the completion button (indicated by (3) in FIG. 3B) or based on, for example, a signal from one of the processing machines MC1 to MC8.

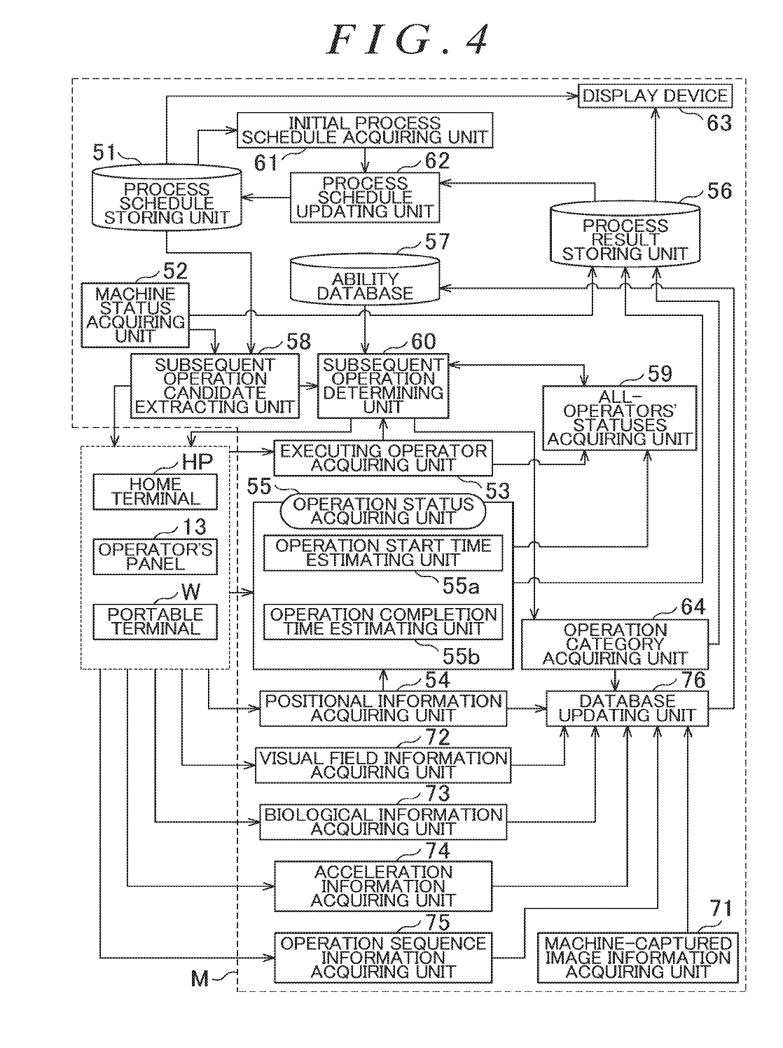

Next, an overview of the management apparatus M is described with reference to FIG. 4. As illustrated in FIG. 4, the management apparatus M includes a process schedule storing unit 51, a machine status acquiring unit 52, an executing operator acquiring unit 53, a positional information acquiring unit 54, an operation status acquiring unit 55, a process result storing unit 56, an ability database 57, a subsequent operation candidate extracting unit 58, an all-operators' statuses acquiring unit 59, a subsequent operation determining unit 60, an initial process schedule acquiring unit 61, a process schedule updating unit 62, a display device 63, an operation category acquiring unit 64, a machine-captured image information acquiring unit 71, a visual field information acquiring unit 72, a biological information acquiring unit 73, an acceleration information acquiring unit 74, an operation sequence information acquiring unit 75, and a database updating unit 76.

Among the units constituting the management apparatus M, the machine status acquiring unit 52 acquires information on current statuses (utilization statuses) of the processing machines MC1 to MC8 from the control devices 12 of the processing machines MC1 to MC8. The machine-captured image information acquiring unit 71 acquires information on images captured by the machine imaging devices 14 of the processing machines MC1 to MC8. The executing operator acquiring unit 53, the positional information acquiring unit 54, the operation status acquiring unit 55, the visual field information acquiring unit 72, the biological information acquiring unit 73, the acceleration information acquiring unit 74, and the operation sequence information acquiring unit 75 acquire information on an executing operator, positional information, information on an operation status, visual field information, biological information, acceleration information, and operation sequence information from the operator's terminal 13, HP, W, respectively.

The executing operator acquiring unit 53 acquires, as information on an executing operator, information on an operator corresponding to an operator's name button that is touched on the operator's terminal 13, HP, W. That is, the executing operator acquiring unit 53 acquires ID information of an operator who executes an operation (operator's name or the like). The other units constituting the management apparatus M perform processing in the management apparatus M, and are described later in detail.

As described above, the management apparatus M has the functions of grasping utilization results, creating updated process schedules, assigning subsequent operations to operators, and constructing an ability database of operators. The function of grasping utilization results is implemented by the process schedule storing unit 51, the machine status acquiring unit 52, the positional information acquiring unit 54, the operation status acquiring unit 55, the process result storing unit 56, the display device 63, and the operation category acquiring unit 64.

The function of creating updated process schedules is implemented by the process schedule storing unit 51, the process result storing unit 56, the initial process schedule acquiring unit 61, and the process schedule updating unit 62. The function of assigning subsequent operations to operators is implemented by the process schedule storing unit 51, the machine status acquiring unit 52, the executing operator acquiring unit 53, the positional information acquiring unit 54, the operation status acquiring unit 55, the ability database 57, the subsequent operation candidate extracting unit 58, the all-operators' statuses acquiring unit 59, and the subsequent operation determining unit 60.

The function of constructing an ability database of operators is implemented by the ability database 57, the positional information acquiring unit 54, the operation category acquiring unit 64, the machine-captured image information acquiring unit 71, the visual field information acquiring unit 72, the biological information acquiring unit 73, the acceleration information acquiring unit 74, the operation sequence information acquiring unit 75, and the database updating unit 76.

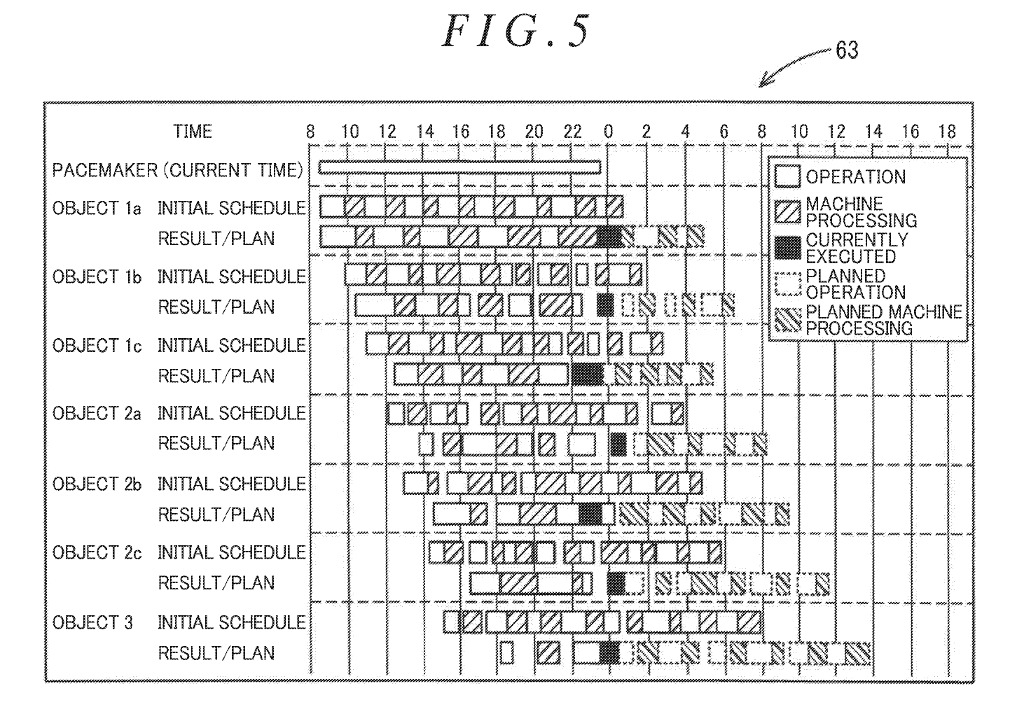

The function of grasping utilization results by the management apparatus M is described with reference to FIG. 4 and FIG. 5. First, an initial process schedule, a process result, and an updated process schedule to be used for the function of grasping utilization results are described with reference to FIG. 5.

FIG. 5 is a diagram illustrating contents to be displayed on the display device 63. FIG. 5 illustrates a pacemaker indicating a current time, initial process schedules for respective objects, which are stored in the process schedule storing unit 51, updated process schedules for the respective objects, which are stored in the process schedule storing unit 51, and process results for the respective objects, which are stored in the process result storing unit 56. Objects 1a, 1b, and 1c are objects of the same type, and objects 2a, 2b, and 2c are objects of the same type. The object refers to an object to be produced (workpiece, assembly, or the like) in the case of a production facility, and an object to be distributed (object to be transported) in the case of a physical distribution facility. The objects 1a, 1b, and 1c, the objects 2a, 2b, and 2c, and an object 3 are objects of different types.

The process schedule refers to a schedule that defines execution sequence of processing to be executed by each of the plurality of processing machines MC1 to MC8 and operations to be executed by an operator on each of the plurality of processing machines MC1 to MC8. The initial process schedule and the updated process schedule are stored in the process schedule storing unit 51. The initial process schedule is determined in advance by a manager based on production planning for each object. The initial process schedule refers to a process schedule that is set based on an operation time of an operator having a standard operation ability (standard time). The updated process schedule refers to a process schedule that is obtained by updating the initial process schedule based on a utilization result of the processing machine and an operation result of the operator. The process result indicates a processing result of each of the processing machines MC1 to MC8 and an operation result of the operator. The process result is stored in the process result storing unit 56.

In FIG. 5, the pacemaker indicates that the current time is about 23:30. The initial process schedule is displayed in an initial schedule field of each object in FIG. 5. In the initial schedule field, a hollow box enclosed by a continuous line represents an operation to be executed by an operator, and a hatched box enclosed by a continuous line represents processing to be executed by one of the processing machines MC1 to MC8.

In a result/plan field of each object in FIG. 5, the process result corresponds to hollow boxes enclosed by continuous lines and hatched boxes enclosed by continuous lines. In the result/plan field, the hollow box enclosed by the continuous line represents an operation result of the operator, and the hatched box enclosed by the continuous line represents a processing result of one of the processing machines MC1 to MC8. In the result/plan field of each object in FIG. 5, the updated process schedule corresponds to hollow boxes enclosed by dashed lines and hatched boxes enclosed by dashed lines. The hollow box enclosed by the dashed line represents a planned operation to be executed by the operator, and the hatched box enclosed by the dashed line represents planned processing to be executed by one of the processing machines MC1 to MC8. In FIG. 5, a solid box represents processing that is currently executed by one of the processing machines MC1 to MC8 or an operation that is currently executed by the operator. A space between boxes represents a time period in which none of the processing machines MC1 to MC8 or operators executes processing or an operation.

The process result storing unit 56 stores the processing results of the processing machines MC1 to MC8 and the operation results of the operators. The processing result of each of the processing machines MC1 to MC8 is information acquired by the machine status acquiring unit 52. The machine status acquiring unit 52 acquires a current status (utilization status) of each of the processing machines MC1 to MC8 from the control device 12 of each of the processing machines MC1 to MC8.

The operation result of each of the operators is information acquired by the operation status acquiring unit 55 and the operation category acquiring unit 64. The operation status acquiring unit 55 acquires information on an operation status of an operator as one element of the operation result. The information on an operation status of an operator refers to information indicating an operation start time, an operation completion time, and whether the operation is in progress or completed.

When the home terminal HP is operated, the operation status acquiring unit 55 uses a start time and a completion time input on the home terminal HP as the start time and the completion time. When the portable terminal W is operated, the operation status acquiring unit 55 estimates a start time and a completion time that would be input on the home terminal HP without using a start time and a completion time input on the portable terminal W. That is, the operation status acquiring unit 55 estimates the start time and the completion time to be input at the home position P based on the start time and the completion time input on the portable terminal W and a distance between a current position and the home position P.

The operation category acquiring unit 64 acquires a category of the operation that is executed by the operator as the other element of the operation result. The operation category acquiring unit 64 acquires the operation category by acquiring a subsequent operation determined by the subsequent operation determining unit 60 described later. Details of the processing to be performed by the operation status acquiring unit 55 and the processing to be performed by the subsequent operation determining unit 60 are described later.

Next, the function of creating updated process schedules by the management apparatus M is described with reference to FIG. 4 and FIG. 5. The function of creating updated process schedules is implemented by the process schedule storing unit 51, the process result storing unit 56, the initial process schedule acquiring unit 61, and the process schedule updating unit 62.

The initial process schedule acquiring unit 61 acquires an initial process schedule stored in the process schedule storing unit 51. The process schedule updating unit 62 creates an updated process schedule as represented by the boxes enclosed by the dashed lines in FIG. 5 based on the initial process schedule acquired by the initial process schedule acquiring unit 61 and a process result stored in the process result storing unit 56.

The process schedule updating unit 62 acquires the initial process schedule from the initial process schedule acquiring unit 61. When the result stored in the process result storing unit 56 is updated, the process schedule updating unit 62 updates the process schedule based on the process result. That is, when the process result shows a delay in the initial process schedule, the process schedule updating unit 62 determines a future process schedule in consideration of the delay. At this time, the operation time of the operator is set based on an operation time of an operator having a standard operation ability.

Next, description is given of the ability database 57 that is used for the function of assigning subsequent operations to operators by the management apparatus M. The ability database 57 stores an operation ability of each operator for each operation category for a plurality of operators and a plurality of operation categories. Examples of the operation category include processes such as set-up, test machining, and recovery from abnormality. Each information is stored for each of the processing machines MC1 to MC8.

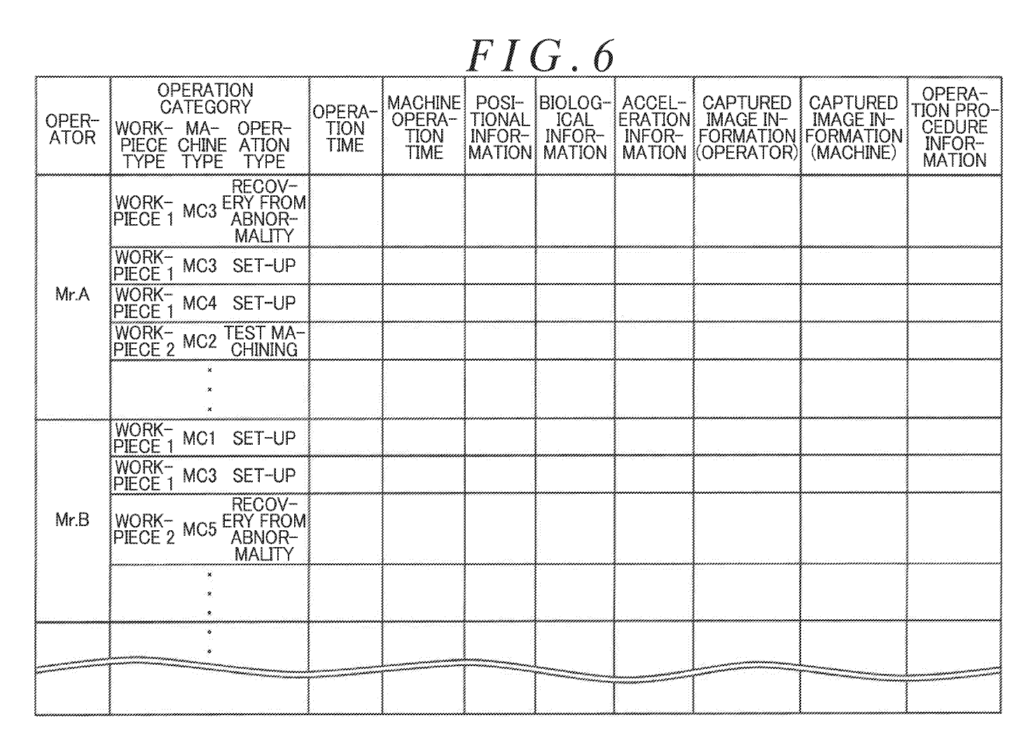

The ability database 57 has operation result information illustrated in FIG. 6. The operation result information includes, for each operator and operation category, an operation time, a machine operation time, positional information, biological information, acceleration information, visual field information indicated by an image captured by the portable-terminal imaging device 34, information indicated by an image captured by the machine imaging device 14, and operation sequence information. The operation time refers to a time from the start to completion of an operation with the home position P set as a reference. The machine operation time refers to a time during which an operation is executed directly on each of the processing machines MC1 to MC8. The machine operation time can be obtained based on, for example, an operation on the operator's panel 13, positional information, machine-captured image information, visual field information, and acceleration information. The operation sequence information refers to information on operation sequence executed by an operator on the operator's panel 13.

As described above, the ability database 57 has a large number of pieces of operation result information. The ability database 57 is constructed by the database updating unit 76. That is, the database updating unit 76 updates the ability database 57 by acquiring information from the positional information acquiring unit 54, the operation category acquiring unit 64, the machine-captured image information acquiring unit 71, the visual field information acquiring unit 72, the biological information acquiring unit 73, the acceleration information acquiring unit 74, and the operation sequence information acquiring unit 75. When operations are executed a plurality of times for the same object, the latest information is stored.

Description is given on the processing to be performed by the all-operators' statuses acquiring unit 59 that is used for the function of assigning subsequent operations to operators by the management apparatus M. The all-operators' statuses acquiring unit 59 receives information on an executing operator acquired by the executing operator acquiring unit 53 and operation statuses acquired by the operation status acquiring unit 55. Specifically, the all-operators' statuses acquiring unit 59 has, for each operator, an input time of operation start information, an estimated time of the start of an operation with the home position P set as a reference, an input time of operation completion information, and an estimated time of the completion of the operation with the home position P set as a reference.

The all-operators' statuses acquiring unit 59 also has information on whether an operator is executing or has completed an operation. The all-operators' statuses acquiring unit 59 determines that the operator is executing the operation when the operation is not completed after the start of the operation, and that the operator has completed the operation when there is no operation started after the completion of that operation.

The all-operators' statuses acquiring unit 59 also has a predicted time of completion of an assigned operation by an operator who is executing the operation. At this time, the all-operators' statuses acquiring unit 59 acquires an operation category assigned to the operator from the subsequent operation determining unit 60, thereby calculating the predicted time in consideration of a standard operation time associated with the operation category.

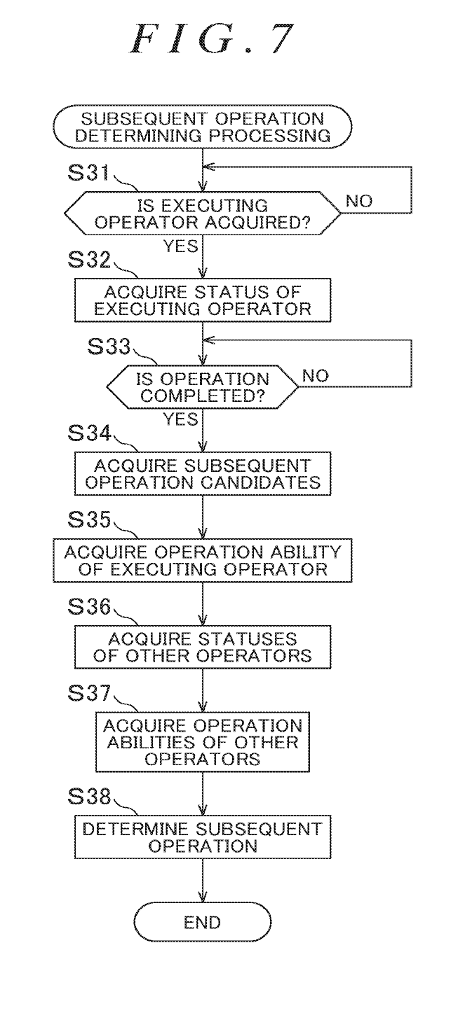

Next, the function of assigning subsequent operations to operators by the management apparatus M is described with reference to FIG. 3A, FIG. 4, and FIG. 7. The function of assigning subsequent operations to operators is implemented by the process schedule storing unit 51, the machine status acquiring unit 52, the executing operator acquiring unit 53, the positional information acquiring unit 54, the operation status acquiring unit 55, the ability database 57, the subsequent operation candidate extracting unit 58, the all-operators' statuses acquiring unit 59, and the subsequent operation determining unit 60.

As illustrated in FIG. 4, the subsequent operation candidate extracting unit 58 acquires current statuses of the plurality of processing machines MC1 to MC8, which are acquired by the machine status acquiring unit 52, and a process schedule stored in the process schedule storing unit 51. Then, the subsequent operation candidate extracting unit 58 extracts candidates for a subsequent operation to be executed by an operator based on the current statuses of the processing machines MC1 to MC8 and the process schedule. The subsequent operation candidates are operations that currently require operators in the entire facility 1. The subsequent operation candidates are displayed in the candidate field 42 of the operator's terminal 13, HP, W in FIG. 3A. When the subsequent operation candidate extracting unit 58 extracts a plurality of subsequent operation candidates, priority levels are determined for the plurality of subsequent operation candidates. The priority levels are also displayed in the candidate field 42 in FIG. 3A.

Next, the subsequent operation determining unit 60 determines a subsequent operation for a predetermined operator. The processing to be performed by the subsequent operation determining unit 60 is described with reference to FIG. 7. The subsequent operation determining unit 60 determines whether an executing operator is acquired from the executing operator acquiring unit 53 (S31). That is, when any operator touches the operator's name button on the operator's terminal 13, HP, W, the subsequent operation determining unit 60 determines that the executing operator is acquired.

When the executing operator is not acquired, the subsequent operation determining unit 60 does not advance the processing (S31: No). When the executing operator is acquired (S31: Yes), the subsequent operation determining unit 60 acquires a status of the executing operator from the all-operators' statuses acquiring unit 59 (S32). Then, the subsequent operation determining unit 60 determines whether the executing operator has completed an operation (S33). When the operation is not completed (S33: No), the subsequent operation determining unit 60 returns to S33 to repeat the processing.

When the operation is completed (S33: Yes), the subsequent operation determining unit 60 acquires the subsequent operation candidates extracted by the subsequent operation candidate extracting unit 58 (S34). Then, the subsequent operation determining unit 60 acquires an operation ability of the executing operator from the ability database 57 (S35). Then, the subsequent operation determining unit 60 acquires statuses of the other operators from the all-operators' statuses acquiring unit 59 (S36). For example, the subsequent operation determining unit 60 acquires statuses as to whether any other operator is currently ready to start a subsequent operation or whether any other operator is about to complete an operation. Then, the subsequent operation determining unit 60 acquires operation abilities of the other operators from the ability database 57 (S37).

Finally, the subsequent operation determining unit 60 determines a subsequent operation for the executing operator based on the subsequent operation candidates, the operation ability of the executing operator, the statuses of the other operators, and the operation abilities of the other operators (S38). The subsequent operation determining unit 60 determines whether the executing operator can execute a subsequent operation candidate having a higher priority level, and determines an executable subsequent operation candidate as a subsequent operation for the executing operator. When any other operator is also ready to start an operation, the subsequent operation determining unit 60 determines a subsequent operation for the executing operator in consideration of the operation ability of the executing operator and the operation abilities of the other operators.

For example, suppose an operator A can execute all operation categories, and operators B, C, and D can execute only some operation categories. In a case of determining a subsequent operation for the operator A, suppose the operator B is currently ready to start a subsequent operation or is about to become ready to start a subsequent operation. When a subsequent operation candidate having a higher priority level is set as an operation category that can be executed by both of the operator A and the operator B, the subsequent operation determining unit 60 determines a subsequent operation candidate having a lower priority level as a subsequent operation for the operator A. The subsequent operation candidate having a higher priority level may not be able to be assigned as a subsequent operation for the operator B, but the subsequent operation candidate having a lower priority level cannot be assigned as a subsequent operation for the operator B in some cases. Therefore, the subsequent operation candidate having a higher priority level is determined as a subsequent operation for the operator B, and the subsequent operation candidate having a lower priority level is determined as a subsequent operation for the operator A. As a result, the subsequent operation candidates can be executed efficiently.

When the subsequent operation candidate having a lower priority level is determined as a subsequent operation, the process schedule is taken into consideration. When the process schedule may be delayed as a result of determining the subsequent operation candidate having a lower priority level as a subsequent operation for an operator, the subsequent operation candidate having a higher priority level is determined as a subsequent operation for the operator instead of determining the subsequent operation candidate having a lower priority level as a subsequent operation for the operator.

As long as the process schedule is not delayed, the subsequent operation determining unit 60 may determine a subsequent operation for an operator having a lower operation ability level than a standard ability level. In FIG. 5, a space between boxes represents a time period in which none of the processing machines MC1 to MC8 or operators executes processing or operation. That is, the subsequent operation determining unit 60 may utilize this idle time to make an allowance by setting a longer operation time than a standard operation time. In this manner, the operator having a lower operation ability level can be trained.

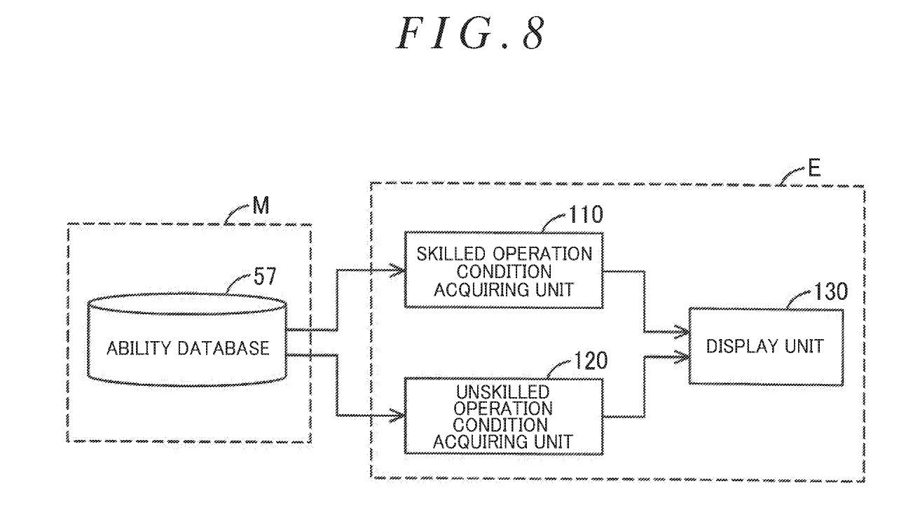

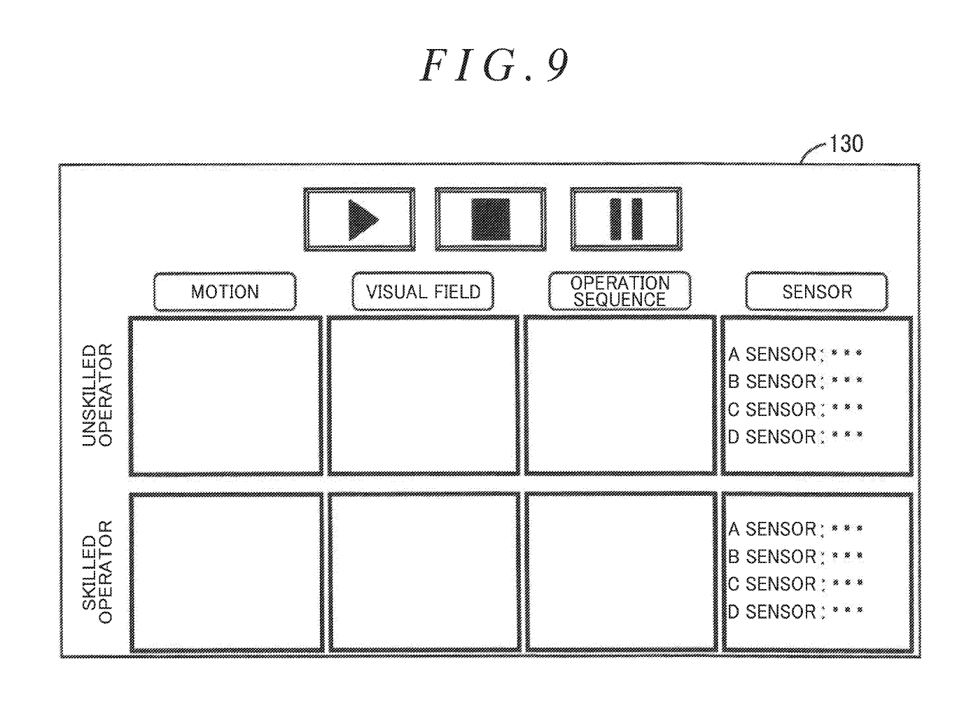

Next, the training assistance apparatus E is described with reference to FIG. 8 and FIG. 9. As illustrated in FIG. 8, the training assistance apparatus E includes a skilled operation condition acquiring unit 110, an unskilled operation condition acquiring unit 120, and a display unit 130.

The skilled operation condition acquiring unit 110 acquires operation conditions of a skilled operator on one of the processing machines MC1 to MC8 in advance from the ability database 57 of the management apparatus M. The skilled operator is a specific operator who is set in advance. For example, the skilled operator is an operator who can complete an operation within an operation time that is much shorter than an operation time of a standard operator (standard time). The skilled operator may be an operator who can provide a high operation quality in addition to the short operation time. The skilled operator is set in association with each operation category.

One specific level or a plurality of levels may be set as the level of the operation ability of the skilled operator. When skilled operators are set as operators having operation abilities at a plurality of levels, the skilled operators may be, for example, an operator having an operation ability at a standard level, and an operator having an operation ability at a level that is higher than the standard level. When skilled operators are set as operators having operation abilities at a plurality of levels, the skilled operation condition acquiring unit 110 acquires operation conditions of the skilled operators having operation abilities at their respective levels.

The unskilled operation condition acquiring unit 120 acquires operation conditions of an unskilled operator on one of the processing machines MC1 to MC8 from the ability database 57 of the management apparatus M. Operators other than the operators who are set as the skilled operators correspond to unskilled operators. When the unskilled operator executes an operation, the unskilled operation condition acquiring unit 120 acquires operation conditions of the unskilled operator so that the operation conditions of the unskilled operator are comparable with the operation conditions acquired by the skilled operation condition acquiring unit 110 for training of the unskilled operator.

Examples of the operation conditions acquired by the skilled operation condition acquiring unit 110 and the unskilled operation condition acquiring unit 120 include motion information indicated by an image of an operator, visual field information of an operator, operation sequence information of an operator on the operator's panel, and information detected by various sensors carried by an operator.

A first operation condition is motion information of an operator (captured image information), which is indicated by an image captured by the machine imaging device 14 (first imaging device) provided on each of the processing machines MC1 to MC8. That is, the motion information (captured image information) is information on motion of each body part of an operator, such as an operator's standing position, facial motion, and arm motion at each of the processing machines MC1 to MC8. The machine imaging device 14 is fixed to each of the processing machines MC1 to MC8, thereby imaging the same visual field from each of the processing machines MC1 to MC8. That is, the motion information of an operator is information on a machine visual field.

A second operation condition is operation sequence information on the operator's panel 13 of each of the processing machines MC1 to MC8. The operation sequence information is, for example, a display screen of the operator's panel 13. Image processing is performed on the screen so as to indicate positions touched by an operator (or positions where information is input by an operator).

A third operation condition is visual field information of an operator, which is indicated by an image captured by the portable-terminal imaging device 34 (second imaging device) carried by the operator. When each of the skilled operation condition acquiring unit 110 and the unskilled operation condition acquiring unit 120 acquires the third operation condition, the type of the portable terminal W is a type with the portable-terminal imaging device 34 mounted on the head of the operator.

A fourth operation condition is acceleration information at a predetermined part of an operator, which is detected by the acceleration sensor 36 carried by the operator. The predetermined part is, for example, the waist, arm, or leg of the operator. As another operation condition, each of the skilled operation condition acquiring unit 110 and the unskilled operation condition acquiring unit 120 may acquire information detected by the biological information sensor 35.

The skilled operation condition acquiring unit 110 may only acquire operation conditions of a skilled operator once. However, the operation ability of the skilled operator will also improve. Therefore, when the operation ability of the skilled operator is improved, it is appropriate that the skilled operation condition acquiring unit 110 update the operation conditions of the skilled operator on one of the processing machines MC1 to MC8.

Determination that the operation ability of the skilled operator is improved may be made, for example, when the shortest operation time for one operation is updated, or when the shortest mean operation time for a plurality of operations is updated. The determination may be made, for example, when the quality of the processed object is improved instead of when the operation time is updated.

The display unit 130 displays the operation conditions acquired by the skilled operation condition acquiring unit 110 and the operation conditions acquired by the unskilled operation condition acquiring unit 120 for comparison. FIG. 9 illustrates display contents of the display unit 130. On a display screen, display panes for displaying motion information, visual field information, operation sequence information, and information from various sensors regarding an unskilled operator are arranged in the order from the left. On the display screen, display panes for displaying motion information, visual field information, operation sequence information, and information from various sensors regarding a skilled operator are arranged below the display panes for the unskilled operator in the order from the left. Those display panes on the display screen display moving images. An upper field of the display screen is provided with operation buttons for reproduction, stop, and pause of the images in the display panes.

All the moving images to be displayed in the display panes can be reproduced in synchronization with each other. Alternatively, selected pieces of information of the unskilled operator and the skilled operator, such as motion information alone, may be reproduced in synchronization with each other.

When the skilled operation condition acquiring unit 110 acquires operation conditions of skilled operators having operation abilities at a plurality of levels, pieces of information of the skilled operators having operation abilities at a plurality of levels may be displayed on the display screen of the display unit 130. Pieces of information of the skilled operators having operation abilities at a plurality of levels may be displayed on the display screen of the display unit 130, or information of a skilled operator having an operation ability at a selected level may be displayed on the display screen of the display unit 130. In the latter case, the display unit 130 displays information in a switchable manner depending on the level of the operation ability of the unskilled operator. For example, in a case of a novice having an operation ability at a level that is lower than a standard level, the display unit 130 may display only information of a skilled operator having an operation ability at the standard level. In a case of an operator having an operation ability at the standard level as a result of learning to some degree, the display unit 130 may be switched so as to display only information of a skilled operator having an operation ability at a high level.

The training assistance apparatus E described above includes the skilled operation condition acquiring unit 110 configured to acquire operation conditions of a skilled operator on one of the processing machines MC1 to MC8 in advance, and the unskilled operation condition acquiring unit 120 configured to acquire, when an unskilled operator executes an operation, operation conditions of the unskilled operator so that the operation conditions of the unskilled operator are comparable with the operation conditions acquired by the skilled operation condition acquiring unit 110 for training of the unskilled operator.

As described above, the training assistance apparatus E acquires the operation conditions of the skilled operator and the operation conditions of the unskilled operator so that a comparison can be made therebetween. By comparing the operation conditions of the skilled operator and the operation conditions of the unskilled operator, the unskilled operator easily grasps differences between the operation executed by the unskilled operator and the operation executed by the skilled operator including know-how. As a result, the unskilled operator can efficiently learn the operational know-how.

As a first operation condition, the skilled operation condition acquiring unit 110 and the unskilled operation condition acquiring unit 120 acquire pieces of motion information of the skilled operator and the unskilled operator, which are indicated by images captured by the machine imaging device 14 (first imaging device) provided on each of the processing machines MC1 to MC8. Therefore, the unskilled operator can easily compare the pieces of motion information of the skilled operator and the unskilled operator, which are indicated by the images captured by the machine imaging device 14. Thus, the unskilled operator can efficiently learn the operational know-how.

As a second operation condition, the skilled operation condition acquiring unit 110 and the unskilled operation condition acquiring unit 120 acquire pieces of operation sequence information on the operator's panel 13 of each of the processing machines MC1 to MC8. Therefore, the unskilled operator can easily compare the pieces of operation sequence information of the skilled operator and the unskilled operator on the operator's panel 13. Thus, the unskilled operator can efficiently learn the operational know-how.

As a third operation condition, the skilled operation condition acquiring unit 110 and the unskilled operation condition acquiring unit 120 acquire pieces of visual field information of the skilled operator and the unskilled operator, which are indicated by images captured by the portable-terminal imaging devices 34 (second imaging devices) carried by the skilled operator and the unskilled operator. Therefore, the unskilled operator can easily compare the pieces of visual field information of the skilled operator and the unskilled operator. Visual field information of an operator indicates operational know-how about the timing and position of observation. Thus, the unskilled operator can efficiently learn the operational know-how.

As a fourth operation condition, the skilled operation condition acquiring unit 110 and the unskilled operation condition acquiring unit 120 acquire pieces of acceleration information at predetermined parts of the skilled operator and the unskilled operator, which are detected by the acceleration sensors 36 carried by the skilled operator and the unskilled operator. Therefore, the unskilled operator can compare values of acceleration at the predetermined parts of the skilled operator and the unskilled operator. Acceleration at a predetermined part of an operator corresponds to motion of the predetermined part of the operator. That is, the acceleration at a predetermined part of an operator is thought to include operational know-how. Thus, the unskilled operator can efficiently learn the operational know-how.

The training assistance apparatus E includes the display unit 130 configured to display the operation conditions acquired by the skilled operation condition acquiring unit 110 and the operation conditions acquired by the unskilled operation condition acquiring unit 120 for comparison. By displaying the operation conditions of the skilled operator and the operation conditions of the unskilled operator on the display unit 130 for comparison, the unskilled operator can easily grasp the difference between the operation executed by the unskilled operator and the operation executed by the skilled operator. As a result, the unskilled operator can efficiently learn the operational know-how.

The skilled operation condition acquiring unit 110 updates the operation conditions of the skilled operator on one of the processing machines MC1 to MC8 when the operation ability of the skilled operator is improved. Not only the operation ability of the unskilled operator but also the operation ability of the skilled operator is further improved as the skilled operator continues to execute the operation. Therefore, the skilled operation condition acquiring unit 110 updates the acquired operation conditions when the operation ability of the skilled operator is improved. Thus, the target operation conditions for the unskilled operator can be set at a higher grade. As a result, the operation ability of the unskilled operator can further be improved. In addition, a higher improvement rate can be expected for the operation ability of the unskilled operator.

What is claimed is:

1. A training assistance apparatus, comprising:
a skilled operation condition acquiring unit configured to acquire an operation condition of a skilled operator on a processing machine in advance; and
an unskilled operation condition acquiring unit configured to acquire, when an unskilled operator executes an operation, an operation condition of the unskilled operator so that the operation condition of the unskilled operator is comparable with the operation condition acquired by the skilled operation condition acquiring unit for training of the unskilled operator.

2. The training assistance apparatus according to claim 1, wherein
the skilled operation condition acquiring unit and the unskilled operation condition acquiring unit are configured to acquire pieces of motion information of the skilled operator and the unskilled operator as the operation conditions, the motion information being indicated by an image captured by a first imaging device provided on the processing machine.

3. The training assistance apparatus according to claim 1, wherein
the skilled operation condition acquiring unit and the unskilled operation condition acquiring unit are configured to acquire pieces of operation sequence information on an operator's panel of the processing machine as the operation conditions.

4. The training assistance apparatus according to claim 1, wherein
the skilled operation condition acquiring unit and the unskilled operation condition acquiring unit are configured to acquire pieces of visual field information of the skilled operator and the unskilled operator as the operation conditions, the visual field information being indicated by an image captured by a second imaging device carried by each of the skilled operator and the unskilled operator.

5. The training assistance apparatus according to claim 1, wherein
the skilled operation condition acquiring unit and the unskilled operation condition acquiring unit are configured to acquire pieces of acceleration information at predetermined parts of the skilled operator and the unskilled operator as the operation conditions, the acceleration information being detected by an acceleration sensor carried by each of the skilled operator and the unskilled operator.

6. The training assistance apparatus according to claim 1, further comprising:
a display unit configured to display the operation condition acquired by the skilled operation condition acquiring unit and the operation condition acquired by the unskilled operation condition acquiring unit for comparison.

7. The training assistance apparatus according to claim 1, wherein
the skilled operation condition acquiring unit is configured to update the operation condition of the skilled operator on the processing machine when an operation ability of the skilled operator is improved.
